(19) United States
(12) Patent Application Publication
(10) Pub. No.: US 2004/0176712 A1
(43) Pub. Date: Sep. 9, 2004

(54) Backbone correction apparatus

(76) Inventor: Cheol Woong Jung, Daejeon-City (KR)

Correspondence Address: LADAS & PARRY, 224 SOUTH MICHIGAN AVENUE, SUITE 1200, CHICAGO, IL, 60604, US

(21) Appl. No.: 10/790,855

(22) Filed: Mar. 2, 2004

(30) Foreign Application Priority Data
Mar. 3, 2003 (KR) 20-2002-0006223

(51) Int. Cl. A22C 17/06

(52) U.S. Cl. 601/84

(57) ABSTRACT

A backbone correction apparatus includes a base plate, a rolling body support unit, and a support frame. The rolling body support unit is rollably connected to the surface of the base plate to accommodate a user lying with his back on the rolling body support unit. The rolling body support unit includes: an upper body unit having a plurality of head and backbone supporting members connected to each other by an elastic member and having a plurality of wheels contacting the base plate, the upper body unit capable of receiving the head and the back of the user; and a lower body unit capable of receiving the hip and the legs and having a plurality of wheels contacting the base plate. Each part in the upper body unit and the lower body unit is movable a top and bottom direction, in a lateral direction, in a slanted direction, in an arcuate direction, and in the up and down directions with respect to the laid user. A support frame rigidly supports the base plate.

### BACKGROUND OF THE INVENTION

1. Field of the Invention

This application relates generally to a backbone correction apparatus and more particularly to a backbone correction apparatus having parts, which supports a laid user, having wheels contacting a planar base plate such that the parts move on the base plate in controlled directions to provide therapeutic and massaging stimulation to the laid user.

2. Description of the Prior Art

Generally, a human backbone including the vertebra made up of small bones that join together in long line to form the backbone or spine is oriented in an up right vertical position such that the area of the weight effected by the gravity is relatively small compared to the backbone of a four legged animal (e.g., a tiger) whose backbone is oriented in the horizontal direction. Therefore, the intervertebral discs that are supposed to form strong joints and absorb spinal compression shock between the small bones of the backbone may get negatively affected by the pressure. Under pressure, the intervertebral discs may, for example, break away from the right position in the backbone or may contract or be constricted by the pressure, or may deform by being bent or warped in an abnormal position. When these happen to the backbone due to the pressure put on by the gravity, the nerves that runs through the backbone also gets negatively affected or stimulated. Consequently, the body parts that are connected to those nerves running in the backbone are negatively affected such that it may cause or pain or ailment to the body.

Further, the human living environment and/or pattern have changed over the several decades causing changes to the human body. One serious problem considered by these changes is that human work/living environments are rather limited to a passive or static environment, and living under such conditions humans tend to maintain a lifestyle of routine and repetitive tasks. These type of life style are considered to cause the backbone problems so prevalent among people in the modern society.

But in the case of animals, their backbones are normally oriented in a horizontal direction. The area affected by the weight under gravity is relatively larger than that of a human backbone. Further, the animals natural movements tend to provide adequate exercise to their backbones, and considereation of all this tend to believe that animals generally do not suffer the backbone problems the modern day humans suffer.

For example, a tiger has a backbone that is normally lying in a horizontal direction and as the tiger walks the backbone is naturally shaped to maintain the natural S-shaped curve, and all this cause the tiger in its natural movements to naturally causing exercise to its backbone, and in the end this allows the tiger to maintain a healthy backbone that is both strong and flexible.

There are several goals that are to be achieved by a backbone apparatus. First, the backbone correction apparatus should not cause excessive pressure to be put on the user of the apparatus such that the user can stay in its most relaxed position as possible, and in that condition, the backbone correction apparatus should be able to maximally and/or adequately relax and/or contract the small bones of the backbone such that the intervertebral discs and the nerves under pressure can recover or heal naturally.

Second, the backbone correction apparatus may utilize and apply the mechanical device and utilize the mechanical force generated by the device, but without the unnatural excessiveness.

Third, the backbone correction apparatus may be able to provide effective pressure or stimulation to almost all bones of the human vertebral column including the seven cervical vertebrae in the neck, the twelve thoracic vertebrae that articulate with the twelve pairs of ribs, and the five lumbar vertebrae of the lower back.

However, there are numerous problems associated with the conventional devices for backbone corrections. According to a conventional device as disclosed in the Korean Patent Application No. 1999-005079, a human body is laid on the device with the backbone running lengthwise to the device, and the bones comprising the backbone are relaxed by repeated rotational and lateral (right to left, and vice versa) movements of the device. The device then applies a momentary pressure to the relaxed backbone, which is intended to cause the bones to correct and find its right position in the backbone.

This device, however, relies on rather simple but forcible mechanical movements of the device, that cause the body to tense up rather than to relax.

Second, the device does not provide the stimulation to the overall backbone structure, but stimulates only the lumbar vertebrae area of the backbone, which may cause unnatural stress to that particular part of the backbone. In particular, the circular and lateral movements of the device are performed by motor(s) that frequently reverses the rotating directions, and this causes the movements not be continuous and but disruptive for each movement.

Third, the correction of the backbone is to be made by a momentary application of pressure or force to the relaxed backbone. A backbone is a living part of body a human body, and therefore a human backbone has the ability to heal itself when it is well rested, for example, for several days. Therefore, any external backbone correction device must compliment and foster the natural healing ability of the human backbone.

Accordingly, there is a need for providing an backbone correction device that provides very effective backbone relaxation, correction, healing, etc., while overcoming the problems associated with the conventional devices.

### SUMMARY OF THE INVENTION

Against this backdrop, embodiments of the present invention have been developed. A backbone correction apparatus according to an embodiment of the present invention includes a base plate, a rolling body support unit, and a support frame. A rolling body support unit is rollably connected to the surface of the base plate to accommodate a user lying with his back on the rolling body support unit. The support frame rigidly supports the base plate.

The rolling body support unit includes an upper body unit and a lower body unit. The upper body unit has a plurality of head and backbone supporting members, which are connected to each other by an elastic member. Each of the supporting members has a plurality of wheels contacting the base plate. The upper body unit is capable of receiving the head and the back of the user.

The lower body unit is capable of receiving the hip and the legs of the user. The lower body unit has a plurality of wheels contacting the base plate.

Each part in the upper body unit and the lower body unit is movable in at least one of the following directions: (1) rollably moving in a top and bottom direction with respect to the head to toe direction of the laid user; (2) rollably moving in a lateral direction with respect to the laid user; (3) rollably moving in a slanted direction with respect to the laid user; (4) rollably moving in a arcuate direction with respect to the laid user; and (5) moving in the up and down directions with respect to the laid user.

The upper body unit is connected to the support frame by an elastic member, and the length of the elastic member is adjustable.

The upper body unit has (1) a head and cervical vertebrae support member having a first wheel contacting the base plate and capable of receiving the head of the user; (2) a cervical and thoracic vertebrae support member having a second wheel contacting the base plate and capable of receiving the neck of the user; (3) a thoracic vertebrae support member having a third wheel contacting the base plate and capable of receiving the part of the back corresponding to the thoracic vertebrae bones; and (4) a lumbar vertebrae support member having a fourth wheel contacting the base plate and capable of receiving the part of the back corresponding to the thoracic vertebrae bones.

The lower body unit has (1) a first lower unit having a fifth wheel contacting the base plate and capable of receiving the hip of the user; and (2) a second lower unit having a sixth wheel contacting the base plate and capable of receiving the legs of the user.

Each of the head and cervical vertebrae support member, the cervical and thoracic vertebrae support member, the thoracic vertebrae support member, the lumbar vertebrae support member has a plurality of protruding parts that stimulates the contact body part of the user.

The backbone correction apparatus according to an embodiment of the present invention further includes at least one of: (1) an auxiliary head and cervical vertebrae support member having a first wheel contacting the base plate and capable of receiving the head of the user; (2) an auxiliary cervical and thoracic vertebrae support member having a second wheel contacting the base plate and capable of receiving the neck of the user; (3) an auxiliary thoracic vertebrae support member having a third wheel contacting the base plate and capable of receiving the part of the back corresponding to the thoracic vertebrae bones; (4) an auxiliary lumbar vertebrae support member having a fourth wheel contacting the base plate and capable of receiving the part of the back corresponding to the thoracic vertebrae bones; and (5) a lower body length adjusting unit that is adjustable to accommodate of the lower body length of the laid user. Each of the auxiliary members is connectable to another auxiliary member or to the non-auxiliary member by an auxiliary elastic member.

Each of the non-auxiliary and auxiliary members of the upper body unit comprises a shock absorbing unit on the side that is connected to the non-auxiliary or auxiliary elastic member. Each of the non-auxiliary and auxiliary member of the upper body unit comprises heating elements to heat the contacting boy of the user.

The first lower unit comprises a retractable hip tightening belt having a locking clip and a clip receiver and a pair of adjustable hip positioning guides to securely receive the hip of the laid user. The hip positioning guides are moved by a motor and controlled by the user.

The second lower unit comprises an adjustable ankle positioning unit to securely receive the ankles of the laid user. The ankle positioning unit is moved by a motor and controlled by the user.

These and various other features as well as advantages which characterize the present invention will be apparent from a reading of the following detailed description and a review of the associated drawings.

### BRIEF DESCRIPTION OF THE DRAWINGS

FIG. 1 is a top view showing the backbone correction apparatus according to an embodiment of the present invention.

FIG. 2 is a perspective view showing a support frame unit of the backbone correction apparatus according to an embodiment of the present invention.

FIG. 3 is a perspective view showing a head and cervical vertebrae support member according to an embodiment of the present invention.

FIG. 4 is a perspective view showing a cervical and thoracic vertebrae support member according to an embodiment of the present invention.

FIG. 5 is a perspective view showing a member that is utilized as either a thoracic vertebrae support member or a lumbar vertebrae support member according to an embodiment of the present invention.

FIG. 6 is a perspective view showing a base plate according to an embodiment of the present invention.

FIG. 7 is a cross-sectional view showing a mechanical system that provides lateral movements to the backbone correction apparatus according to an embodiment of the present invention.

FIG. 8 is a perspective view showing a motor and connected gears that powers the mechanical system of FIG. 7 for lateral movements according to an embodiment of the present invention.

FIG. 9 is a cross sectional view of a lower body length adjusting unit according to an embodiment of the present invention.

FIG. 10 is a cross sectional view of showing a screw-type interconnection utilized in the lower body length adjusting unit of FIG. 9.

FIG. 11 is a block diagram generally showing the electronic control of the backbone correction apparatus according to an embodiment of the present invention.

FIG. 12 is a perspective view showing the main components of the backbone correction apparatus showing separately a rolling body support unit, a base plate, and a support frame unit according to an embodiment of the present invention.

### DETAILED DESCRIPTION

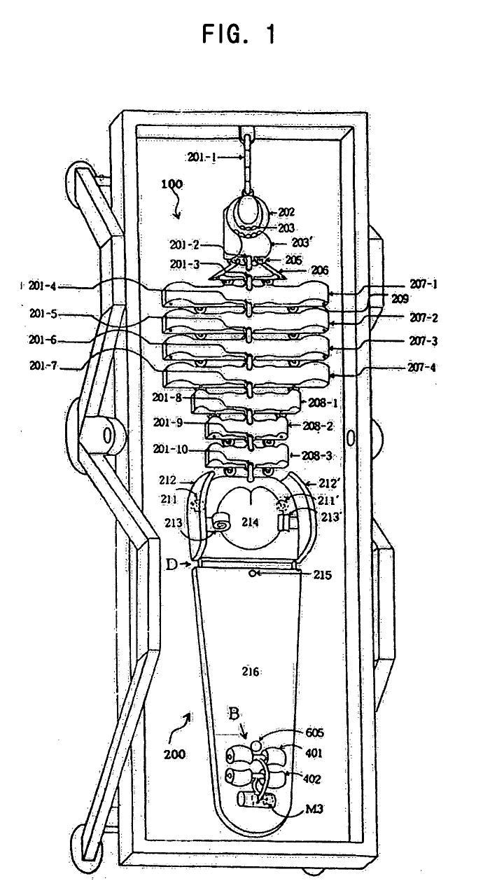

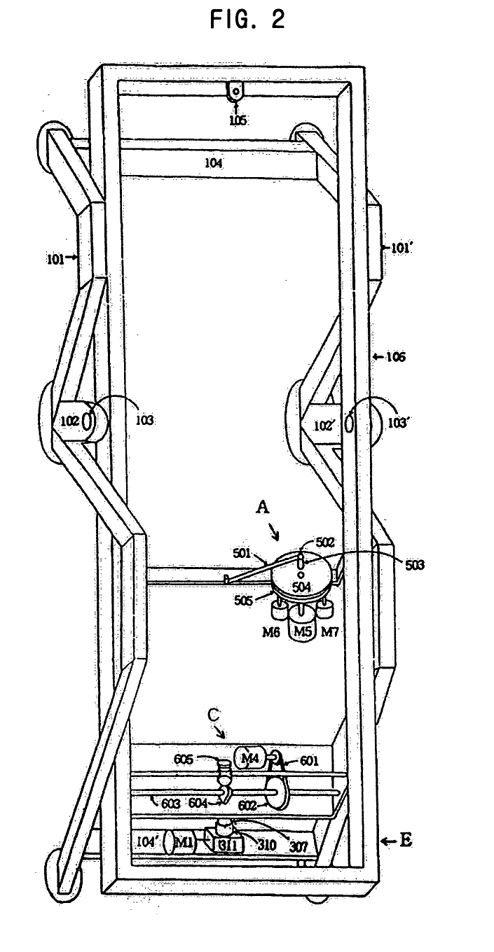

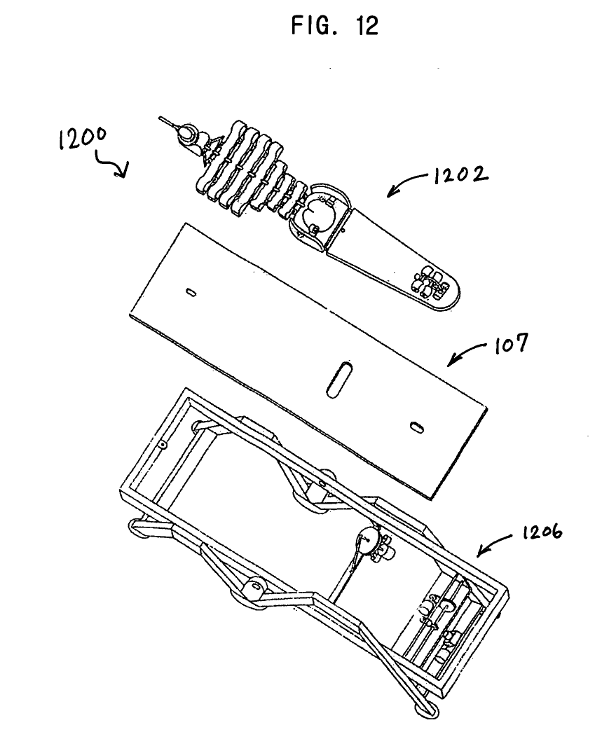

FIGS. 1 and 12 provides an overview of the components that make up a backbone correction device according to an embodiment of the present invention. As shown in FIG. 12, a backbone correction apparatus 1200 according to an embodiment of the present invention comprises a rolling body support unit 1202, a base plate 107 having holes, and a support frame unit 1206. In general, the support frame unit 1206 (see also FIG. 2) firmly holds the base plate 107 and the rolling body support unit 1202, which is placed on the base plate 107. The support frame unit 1206 also includes electrical components, electronic control units, motors, etc. that deliver power to and control movements (through the holes) of the parts that make up the rolling body support unit 1202.

The rolling body support unit 1202 comprises an upper body unit 100 and a lower body unit 200 as shown in FIG. 1.

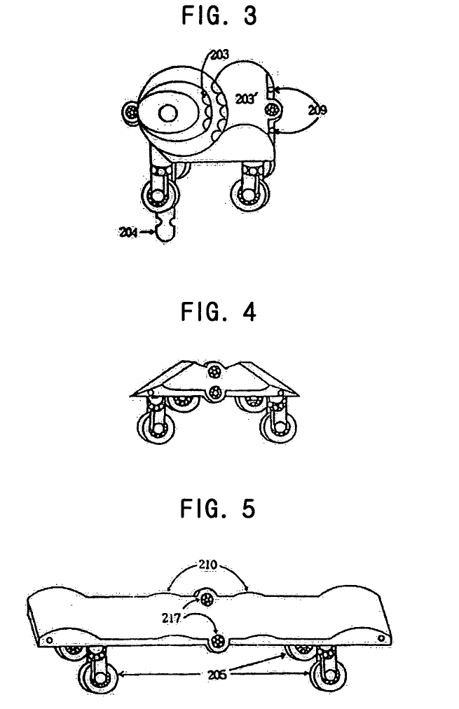

The upper body unit 100 includes a head and cervical vertebrae support member 202 (see also FIG. 3); a cervical and thoracic vertebrae support member 206 (also see FIG. 4); thoracic vertebrae support members 207-1, 207-2, 207-3, and 207-4; and lumbar vertebrae support members 208-1, 208-2, and 208-3. The lower body unit 200 includes a first lower unit 214 and a second lower unit 216.

In the upper body unit 100, the head and cervical vertebrae support member 202 (which supports the head and the cervical vertebrae of a person lying with his or her back on the backbone correction apparatus 1200) is connected to an eye (or a hook) 105 (FIG. 2) of the support frame unit 1206 by a first elastic member 201-1. The head and cervical vertebrae support member 202 is also connected to the cervical and thoracic vertebrae support member 206 with a second elastic member 201-2 in the direction that is generally opposite to the direction of the first elastic member 201-1 as shown in FIG. 1.

The cervical and thoracic vertebrae support member 206 is in then connected to the first one of the four thoracic vertebrae support members 207-1 by a third elastic member 201-3. The four thoracic vertebrae support members 207-1, 207-2, 207-3, and 207-4 are connected in order by fourth, fifth, and sixth elastic members 201-4, 201-5, and 201-6. The last thoracic vertebrae support member 207-4 is then connected to the first three lumbar vertebrae support member 208-1 by a seventh elastic member 201-7. The three thoracic vertebrae support members 208-1, 208-2, and 208-3 are connected to each other by eighth and ninth elastic members 201-8 and 201-9.

On the underside of each component of the upper body unit 100 (i.e., 202, 206, 207-1, 207-2, 207-3, 207-4, 208-1, 208-2, 208-3, etc.) is equipped with one or more of rolling wheels 205 (see FIGS. 1 and 3-5) that are rotatable 360 degrees. For example, the cervical and thoracic vertebrae support unit 206 has four rolling wheels 205 (FIGS. 1 and 4) that roll on the surface of the base plate 107.

Further, each component of the upper body unit 100 may include one or more of protruding parts (such as 203 and 210) that are designed to stimulate the pressure points and/or the spots in the body that are regarded as important for acupuncture or healing according to the traditional Korean medicine (also known as the Oriental medicine, or the Chinese medicine, or the Eastern medicine). For example, each of the support members (207-1, 207-2, 207-3, 207-4, 208-1, 208-2, 208-3) may be equipped with two protruding parts 210 as shown in FIG. 5.

In addition, each component of the upper body unit 100 may include one or more of shock absorbing units. For example, two shock absorbing units 209 are present in the head and cervical vertebrae support member 202 as shown in FIG. 3 to lessen the shock due to the collision with the cervical and thoracic vertebrae support member 206. As already described above, the support members 202 and 206 are connected by the second elastic member 201-2.

Further yet, each component of the upper body unit 100 may also include an auxiliary support unit.

The last thoracic vertebrae support member 208-3 is connected to the first lower unit 214 by a tenth elastic member 201-10. On either side of the first lower unit 214, there are two hip tightening belt units 213 and 213′ and two hip-positioning guides 212 and 212′.

Below the first lower unit 214, there are two 360-degree rotatable wheels 211 and 211′. That is, all or almost all components of the rolling body support unit 1202 (including both the upper and lower body units 100 and 200) have one or more wheels through which each component rests on the base plate 107, and all or almost all components are connected to each other or to the support frame unit 1206 by an elastic member.

The first lower unit 214 is connected to the second lower unit 216 with a lower body length adjustment unit D. The lower body length adjustment unit D, as implied by its name, adjusts the appropriate length of the lower body unit 200 to fit the person lying with his back on the rolling body support unit 1202.

Below the second lower unit 216, there is a lateral movement unit A attached to the support frame unit 1206 (FIG. 2). The lateral movement unit A is connected to a connecting part 215 of the second lower unit 216 to provide the lateral movements of the lower body unit 200, for example, to right and left directions with respect to the person lying on the rolling body support unit 1202.

The lower part of the second lower unit 206 is connected to a downward moving unit C (FIG. 2) by an trigger-shaped anchor 605 (both FIGS. 1-2), such that the downward moving unit C may extend move in the downward and upward directions with respect to the user lying on the upper and lower body units 100, 200 with her or her back.

Toward the end of the second lower unit 216, an ankle-positioning unit B holds the ankle in place and further may provide desired pressure to the ankle for messaging or therapeutic effects if or when desired by the user.

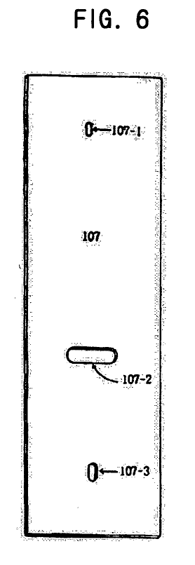

Accordingly, the upper body unit 100 and the lower body unit 200 of the rolling body support unit 1020 operate on the surface of the base plate 107 (FIGS. 6 and 12). The base plate 107 is secured to the rectangular frame 106 (FIG. 2 and 12).

As shown in FIG. 2, the support frame unit 1206 includes, inter alia, the rectangular frame 106 supported by W-shaped left and right bases 101 and 101′. The two W-shaped bases 101 and 101′ are securely connected to each other by two transverse members 104 and 104′ as shown in FIG. 2. In the middle of each of the W-shaped left and right bases, 101 and 101′, a left support 102 and a right support 102′ are respectively formed. The rectangular frame 106 is connected to the right and left supports 102 and 102′ by two rotating rolls 103 and 103′ as shown in FIG. 2.

A tilt control unit E also shown in FIG. 2 controls the tilt of the rectangular frame 106.

Now referring to FIGS. 1 and 3, the head and cervical vertebrae support member 202 is generally shaped to resemble the back of a human head and the contour of the cervical vertebrae. A plurality of protrusions 203, 203′ are located in the head and cervical vertebrae support member 202 to simulate the spots or the pressure points that are considered to be important according to the traditional Korean (or Oriental or Eastern) medicine and/or the acupuncture. A vertical bar 204 (FIG. 3) is fitted through the first hole 107-1 of the base plate 107 (FIG. 6) to prevent excessive side-wise movements of the head and cervical vertebrae support member 202 as the other components are moving laterally either right to left, which may cause dizziness to the user. As shown in FIG. 3, a plurality of rolling wheels that are 360 degree rotatable are formed underside the head and cervical vertebrae support member 202, which allows the head and cervical vertebrae support member 202 to move based on the force or movements transmitted by the cervical and thoracic vertebrae support member 206. The two shock absorbing units 209 lessen the sudden and excessive impacts between the members 202 and 206. On the upper and lower sides of the head and cervical vertebrae support member 202, two elastic connect members (not numbered in FIG. 3 but numbered as 217 in FIG. 5), which has a built-in bearing. Similar elastic connect members (such as 217) are shown in FIGS. 3-5.

As shown in FIG. 4, the cervical and thoracic vertebrae support member 206 is shaped to generally resemble the contour of the cervical vertebrae and thoracic vertebrae. The cervical and thoracic vertebrae support member 206 is equipped with one or more of rolling wheels (e.g., four is shown in FIG. 4); one or more of shock absorbing units (which in the case of FIG. 4, there are four); and one or more of elastic connect member (e.g., two is shown in FIG. 4). The cervical and thoracic vertebrae support member 206 is connected to the first one of the four thoracic vertebrae support members 207-1 and is capable of moving in all directions: up, down, and sideways.

Each of the thoracic vertebrae support members 207-1, 207-2, 207-3, and 207-4 and the lumbar vertebrae support members 208-1, 208-2, and 208-3 as shown in FIG. 5. The surface of each member (207-1 to 4 and 208-1 to 3) is or can be designed to radiate heat using infrared red or others by, for example, having coils or wires for heating. 360 degree rotatable rolling wheels are equipped underside each member (207-1 to 4 and 208-1 to 3). On the upper side, two protruding parts 210 for stimulating the contacting body of the user. Four shock absorbing units 209 are formed on ether side of each member (207-1 to 4 and 208-1 to 3).

The lumbar vertebrae is generally known to be capable of greater degree of movements among human vertebral bones. Thus, the lumbar vertebrae support members (208-1 to 3) are designed to cover the range of movements that the lumbar vertebrae is capable of. Further, one or more auxiliary lumbar vertebrae support member(s) may be utilized depending on the length of the upper body of a user. Each member (207-1 to 4 and 208-1 to 3) has two elastic connect members with built-in bearing 217 as shown in FIG. 5.

As already discussed, the length of the upper body unit 100 may be adjusted by employing additional auxiliary member(s) of the same or substantially similar kind shown in FIG. 5.

The elastic connect members 217 has built-in bearings that allows smooth movements, especially in the right and left directions.

The length of the first elastic member 201-1 may be variable depending on the addition or removal of auxiliary vertebrae support member(s). For this reason, as shown in FIG. 1, the first elastic member 201-1 is divided into several intervals for adjusting the length. For example, the placement of a hook at an end of the first elastic member 201-1 may be chosen in any of the intervals or several intervals may be clamped to adjust the length. Other methods to adjust the length are possible which would be readily understood by those skilled in the pertinent art.

The second to tenth elastic members (201-2 to 201-10) are designed to allow and withstand the pendulum and/or various motions of the body. As the body moves in directions such as up and down, the weight put on each member supporting the vertebral bones connected by the elastic members (201-2 to 201-10) is different. Therefore, elastic member toward the end is more elastic than the elastic member above. For example, the tenth elastic member would be more elastic than the ninth, which would be more elastic than the eighth, etc. This allows the natural pendulum like movement of the backbones including the cervical, thoracic, and lumbar vertebrae.

The first lower unit 214 is connected to the last one of the lumbar vertebrae support member 208-3 by an elastic member 201-10, which is connected to an elastic connect member 217 located on the upper part of the first lower unit 214. As shown in FIG. 1, two rolling wheels 211 and 211′ are equipped underside the first lower unit 214 and facilitates the first lower unit 214 to move in all directions: up, down, and sideways.

The lateral movement unit A, the lower body length adjustment unit D, and the downward moving unit C are placed below the second lower unit 216. The ankle positioning unit B is placed on the upper side of the second lower unit 216.

The eye 105 and the base plate 107 are securely connected to the rectangular frame 106. The base plate 107 as shown in FIG. 6 is made from a material that facilitates easy round or linear motions of the components of the rolling body support unit 1202 (FIG. 12). The first hole 107-1, a second hole 107-2, and a third hole 107-3 are also formed on the base plate 107 as shown in FIG. 6.

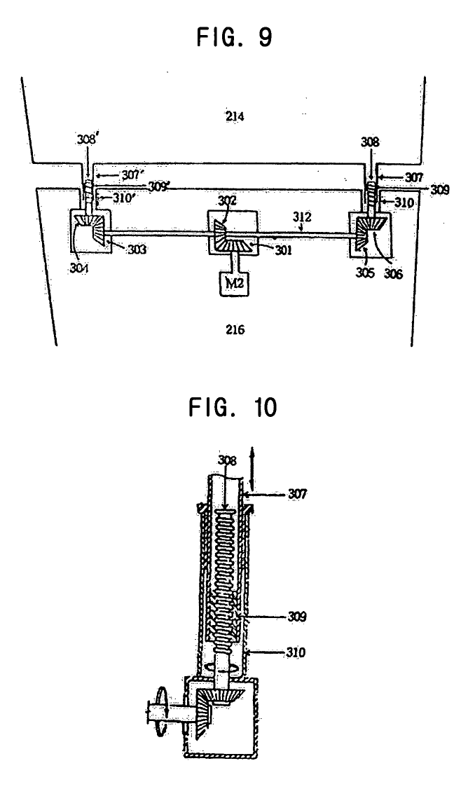

The lower body length adjusting unit D as shown in FIG. 9 is positioned underside of the second lower unit 216. The motor M2 (forward and reverse turning) essentially drives the screws 308 and 308′ through a series of gears and axels (such as 301, 301, 312, 303, 304, 305, and 306 as shown in FIG. 9). As the screws 308 and 308′ rotates inside the extensioning parts 307, 307′, 309, 309′, 310, 310′, the end of the second lower unit 216 can be extended downward or shortened upward closer to the first lower unit 214. The extensioning parts 307, 307′, 309, 309′, 310, 310′ are further illustrated in FIG. 10 in detail.

The downward moving unit C as shown in FIG. 1 is powered by a motor M4 (forward and reverse turning). A belt 601 connects the motor M4 to a pulley 602 of the axel 603, in the middle of which an eccentric cam 604 is positioned. Powered by the motor M4, the eccentric cam 604 turns to apply downward pressure to the end of the trigger-shaped anchor 605, which lowers the second lower part downward. The recovery upward is achieved by the elastic strength of the first elastic member 210-1.

The ankle positioning unit B as shown in FIG. 1 is operated by a forward and reverse turning motor M3 which moves the upper ankle contact part 401 toward the lower ankle contact part 402, and vice versa, to securely hold the ankles in place.

The lateral movement unit A is capable of making either big lateral (or left to right) movements or small lateral movements, which are described below in respect to FIGS. 2, 7-8 and 11.

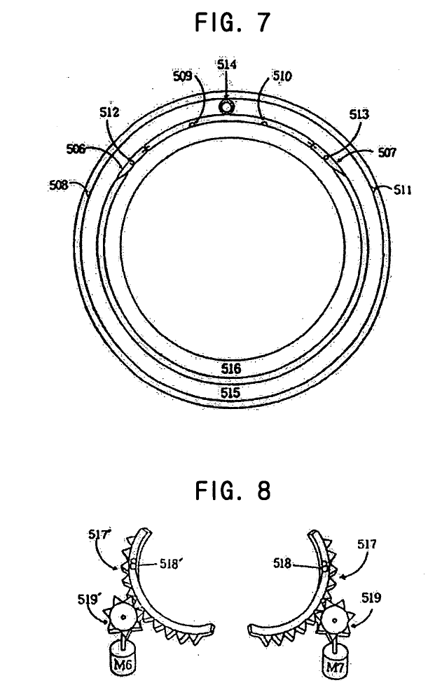

In the case of big lateral movements, as shown in FIG. 1, a forward or reverse turning motor M5 turns the rotating disc 504, which in turn operates the turning wheel 514, now referring to FIG. 7, along the outer arcuate path 515 and the inner arcuate path 516. If the turning wheel 514 is located in the outer arcuate path 515, a first sensor 508 detects the turning wheel 514, and the turning wheel 514 moves along the outer arcuate path 515 with a first door 506 and a second door 507 in the closed position.

FIG. 7 generally corresponds to the rotating wheel mechanism 505 shown in FIG. 1. That is, the rotating disc 504 is overlapped with the rotating wheel mechanism 505 in FIG. 1, and, when the motor M5 operates, the rotating disc 504 moves accordingly with the turning wheel 514 along the chosen arcuate path 515 or 516 (as shown in FIG. 7) in the rotating wheel mechanism 505. The rotating disc 504 has a pin 502 connected to a first end of a rod 501 as shown in FIG. 2, and accordingly, the round motion of the first end of the rod 501 is translated into the linear motion of the other end of the rod 501.

If the turning wheel 514 is located in the inner arcuate path 516, a third sensor 510 detects the turning wheel 514, upon detection a forward or reverse turning motor M7 (as shown in FIGS. 2 and 8) operates to open a second door 507. To open or close the second door 507, a round saw-tooth gear 519 moves the arcuate saw-tooth gear 517 as shown in FIG. 8. A second pin 518 is attached to the arcuate saw-tooth 517 and is also connected to or fitted into a second door fitting part 513 of the second door 507. Therefore, the motor M7 operates to close or open the second door 507, whose second door fitting part 513 is fitted into the second pin 518.

When the second door 507 is opened, the turning wheel 514 in the inner arcuate path 516 is propelled by a spring 502 into the outer arcuate path 515. When the turning wheel 514 in the outer arcuate path 515 is detected by a fourth sensor 511, the second door 507 closes in the similar manner as described above with an exception that the motor M7 is turning in a direction opposite to direction for opening the second door 507. This allows the turning wheel 514 to move along the outer arcuate path 515 and accordingly provides a big lateral movements.

In the case of small lateral movements, the turning wheel 514 moves in either the inner or outer arcuate paths 516, 515 as the rotating disc 504 rotates. If the turning turning wheel 514 is located in the outer arcuate path 515, the first door 506 is opened as the first sensor 508 detects the turning wheel 514 and allows the turning wheel to move into the inner arcuate path 516. The first door 506 closes as the turning wheel 514 moving inside the inner arcuate path 516 is detected by a second sensor 509. As the turning wheel 514 moves along the inner arcuate path 516, the small lateral movements are achieved. The mechanical operations involving the forward and reverse turning motor M6, a round saw-tooth gear 519′ connected to the motor M6, an arcuate saw-tooth gear 517′, a first pin 518′ and the first door fitting part 512 attached to the first door 506 are substantially similar to the operations involved with respect to the opening and closing of the second door 507. Accordingly, duplicative explanations of these parts are not made here.

If the turning wheel 514 is already located in the inner arcuate path 516, the third sensor 510 would detect the turning wheel and closes the first door 506 and the second door 507, and allows the turning wheel to move along the inner arcuate path 516, that in turn provides the small lateral movements.

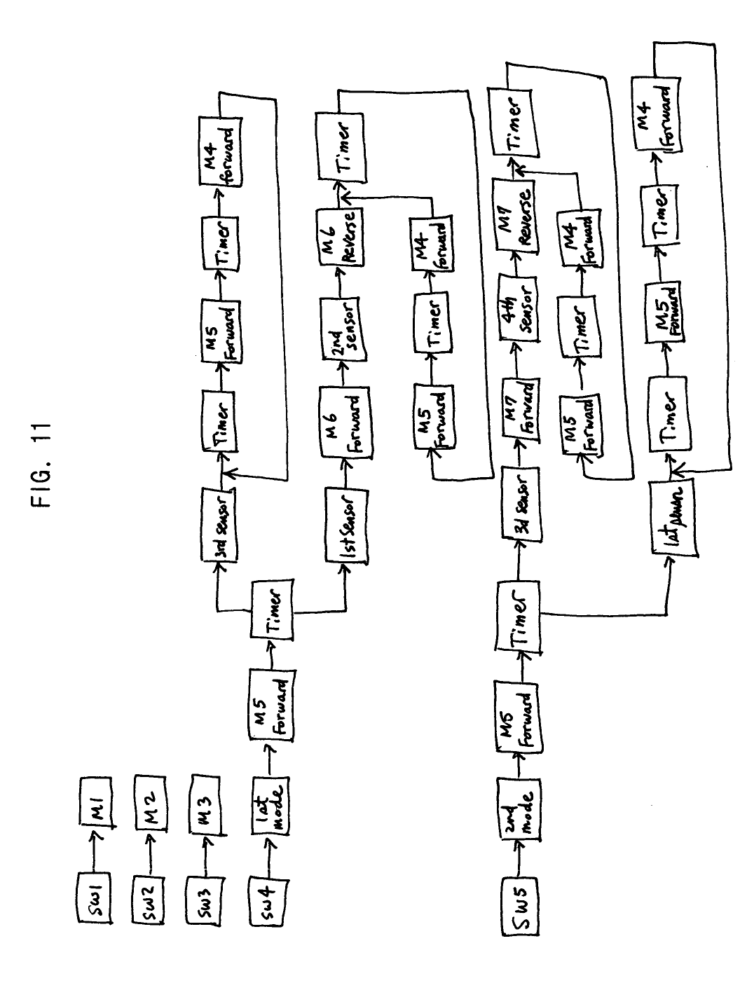

All these operations may be performed automatically and/or manually with utilization of an electronic and/or computerized control system. Although various control operations of the parts as described above are possible, one exemplary explanation of the control for the apparatus according to an embodiment of the present invention is herein described with respect to FIG. 11.

First, a user may adjust the length of the upper body unit 100 by adding or deleting one or more of the vertebrae support members (e.g., 207-1 to 207-4, 208-1 to 208-3, an auxiliary vertebrae support member). The user then lies with his or her back on the upper and lower body units 100, 200.

Using a switch SW2, which controls the motor M2, the user also adjusts the length of the lower body unit 200 by controlling the lower body length adjustment unit D.

Using a switch SW3, which controls the motor M3, the user adjusts the ankle positioning unit B.

The two hip-positioning guides 212 and 212′ can likewise be electronically controlled using a switch and a motor.

Using switch SW1, which controls the motor M1, the user adjusts the tilt control unit E.

The apparatus may be preset with various routines for lateral and/or downward and upwards movements by operating the downward moving unit C and the lateral movement unit A. Two routines are shown in FIG. 11 as for example. For a user with more flexible body may choose to operate backbone correction apparatus according to an embodiment of the present invention by using a switch SW4. Otherwise, the backbone correction apparatus my run by using a switch SW5.

At the end of the routine (or when the user choose to end the routine), the user can hit the “off” switch and release the hip tightening belt 213, 213′ and the ankle positioning unit B.

As described above, the backbone correction apparatus according to an embodiment of the present invention applies movements that are natural to the human body, and provides therapeutic and correctional effects to the backbone without applying excessive artificial and unnatural mechanical forces to the user's body. Accordingly, the backbone correction apparatus according to an embodiment of the present invention in natural to the human body in similar theory comparable to the S-shaped curve of an moving four legged animal and the natural waves of a water in a pond.

The backbone correction apparatus is effective for treating ailments related to the ailing backbone and/or central nervous systems (e.g., spinal stenosis, herniated discs, sculeosis, sciatica, headache, shoulder pains, numbness of extremities, illness related to heart, liver, stomach, pancreas, reproductive system, etc.).

It will be clear that the present invention is well adapted to attain the ends and advantages mentioned as well as those inherent therein. While a various embodiments including the presently preferred one has been described for purposes of this disclosure, various changes and modifications may be made, which are well within the scope of the present invention. Numerous other changes may be made which will readily suggest themselves to those skilled in the art and which are encompassed in the spirit of the invention disclosed and as defined in the appended claims.

What is claimed is:

1. A backbone correction apparatus, comprising:
a base plate;
a rolling body support unit rollably connected to the surface of the base plate to accommodate a user lying with his back on the rolling body support unit, wherein the rolling body support unit comprises:
an upper body unit having a plurality of head and backbone supporting members connected to each other by an elastic member and having a plurality of wheels contacting the base plate, the upper body unit capable of receiving the head and the back of the user; and
a lower body unit capable of receiving the hip and the legs and having a plurality of wheels contacting the base plate,
wherein each part in the upper body unit and the lower body unit is movable in at least one of the directions including:
rollably moving in a top and bottom direction with respect to the head to toe direction of the laid user;
rollably moving in a lateral direction with respect to the laid user;
rollably moving in a slanted direction with respect to the laid user;
rollably moving in an arcuate direction with respect to the laid user; and
moving in the up and down directions with respect to the laid user.

2. The backbone correction apparatus of claim 1, further comprising a support frame rigidly supporting the base plate, wherein the upper body unit is connected to the support frame by an elastic member and further wherein the length of the elastic member is adjustable.

3. The backbone correction apparatus of claim 1 further comprising:
a first motor;
a first mechanical system connected to the first motor and a selected member of the rolling body support unit to translate the rotational motion of the first motor into the lateral movements of the selected member of the rolling body support unit on the base plate;
a second motor;
a second mechanical system connected to the second motor and another selected member of the rolling body support unit to translate the rotational motion of the first motor into the up and down movements of the selected member of the rolling body support unit on the base plate;
a electronic control system allowing the user to control the first and second motors so as to control the lateral and up and down movements.

4. The backbone correction apparatus of claim 1, wherein the upper body unit comprises:
a head and cervical vertebrae support member having a first wheel contacting the base plate and capable of receiving the head of the user;
a cervical and thoracic vertebrae support member having a second wheel contacting the base plate and capable of receiving the neck of the user;
a thoracic vertebrae support member having a third wheel contacting the base plate and capable of receiving the part of the back corresponding to the thoracic vertebrae bones,
a lumbar vertebrae support member having a fourth wheel contacting the base plate and capable of receiving the part of the back corresponding to the thoracic vertebrae bones; and
wherein the lower body unit comprises:
a first lower unit having a fifth wheel contacting the base plate and capable of receiving the hip of the user; and
a second lower unit having a sixth wheel contacting the base plate and capable of receiving the legs of the user.

5. The backbone correction apparatus of claim 4, wherein each of the head and cervical vertebrae support member, the cervical and thoracic vertebrae support member, the thoracic vertebrae support member, the lumbar vertebrae support member has a plurality of protruding parts that stimulates the contact body part of the user.

6. The backbone correction apparatus of claim 4, further including at least one of:
an auxiliary head and cervical vertebrae support member having a first wheel contacting the base plate and capable of receiving the head of the user;
an auxiliary cervical and thoracic vertebrae support member having a second wheel contacting the base plate and capable of receiving the neck of the user;
an auxiliary thoracic vertebrae support member having a third wheel contacting the base plate and capable of receiving the part of the back corresponding to the thoracic vertebrae bones;
an auxiliary lumbar vertebrae support member having a fourth wheel contacting the base plate and capable of receiving the part of the back corresponding to the thoracic vertebrae bones; and
a lower body length adjusting unit that is adjustable to accommodate of the lower body length of the laid user,
wherein each of the auxiliary members is connectable to another auxiliary member or to the non-auxiliary member by an auxiliary elastic member.

7. The backbone correction apparatus of claim 6, wherein each of the non-auxiliary and auxiliary member of the upper body unit comprises a shock absorbing unit on the side that is connected to the non-auxiliary or auxiliary elastic member.

8. The backbone correction apparatus of claim 6, wherein each of the non-auxiliary and auxiliary member of the upper body unit comprises heating elements to heat the contacting boy of the user.

9. The backbone correction apparatus of claim 4, wherein the first lower unit comprises a retractable hip tightening belt having a locking clip and a clip receiver and a pair of adjustable hip positioning guides to securely receive the hip of the laid user.

10. The backbone correction apparatus of claim 9, wherein the hip positioning guides are moved by a motor and controlled by the user.

11. The backbone correction apparatus of claim 4, wherein the second lower unit comprises an adjustable ankle positioning unit to securely receive the ankles of the laid user.

12. The backbone correction apparatus of claim 11, wherein the ankle positioning unit are moved by a motor and controlled by the user.
